(19) United States
(12) Patent Application Publication
(10) Pub. No.: US 2016/0089568 A1
(43) Pub. Date: Mar. 31, 2016

(54) EXERCISE ANALYSIS DEVICE, EXERCISE ANALYSIS SYSTEM, EXERCISE ANALYSIS METHOD, AND PROGRAM

(71) Applicant: SEIKO EPSON CORPORATION, Tokyo (JP)

(72) Inventor: Kazuhiro SHIBUYA, Shiojiri-shi (JP)

(21) Appl. No.: 14/855,841

(22) Filed: Sep. 16, 2015

(30) Foreign Application Priority Data
Sep. 26, 2014 (JP) 2014-197268

(51) Int. Cl. A63B 24/00; A63B 71/06; G09B 19/00

(52) U.S. Cl. CPC A63B 24/0006; G09B 19/0038; A63B 71/0619; A63B 2220/34

(57) ABSTRACT

An exercise analysis device includes: a data acquisition unit that acquires detection data of angular velocities generated around a plurality of axes in a swing exercise of a user; and a motion detection unit that detects a motion of the swing exercise using detection data of an angular velocity generated by radial deviation or ulnar deviation of a wrist of the user among the detection data.

### BACKGROUND

1. Technical Field

The present invention relates to an exercise analysis device, an exercise analysis system, an exercise analysis method, and a program.

2. Related Art

JP-A-10-43349 discloses a swing diagnosis device that, for example, detects motions of golf swings such as a backswing, a downswing, an impact based on signals from an acceleration sensor fitted on a wrist or the back of a hand of a user and determines suitability or non-suitability of a swing rhythm or goodness or badness of an impact state.

However, golf swings are swing exercises in which a rotation direction is switched between a backswing and a downswing and an angle formed between a swing plane and a detection axis of the acceleration sensor fitted on a wrist or the back of a hand of a user is changed according to a change in the posture of the wrist or the back of the hand of the user between the backswing and the downswing. Therefore, it is difficult to specify accurately a timing at which the rotation direction of a swing is switched based on a signal from the acceleration sensor. Accordingly, the swing diagnosis device disclosed in JP-A-10-43349 can detect the start or end of a swing and an impact of the swing. However, in practice, there is a problem that it is difficult to accurately detect the top of a swing or an accumulation state at the top. When a timing of the top may not be accurately specified, for example, a ratio (swing rhythm) of a backswing to a downswing may not be accurately calculated, and thus it is difficult to provide useful information to the user. Such problems are problems occurring not only in golf swings but also swing exercises of baseball or tennis.

### SUMMARY

An advantage of some aspects of the invention is to provide an exercise analysis device, an exercise analysis system, an exercise analysis method, and a program capable of detecting a motion in a swing exercise of a user more accurately.

The invention can be implemented as the following forms or application examples.

### Application Example 1

An exercise analysis device according to this application example includes: a data acquisition unit that acquires detection data of angular velocities generated around a plurality of axes in a swing exercise of a user; and a motion detection unit that detects a motion of the swing exercise using detection data of an angular velocity generated by radial deviation or ulnar deviation of a wrist of the user among the detection data.

By noting that an angular velocity is necessarily generated by rotation and a change amount of angular velocity is large at the time of switching of a swing in a swing exercise, the exercise analysis device according to this application example detects the motion of the swing exercise using the detection data of each angular velocity generated around the plurality of axes, unlike a device of the related art that detects a motion of a swing using detection data of acceleration. Accordingly, in the exercise analysis device according to this application example, it is possible to detect the motion in the swing exercise more accurately than the device of the related art.

In the exercise analysis device according to this application example, it is possible to detect the motion of the swing exercise with high accuracy using the angular velocity generated by radial deviation or ulnar deviation of a wrist of a user in the swing exercise of the user.

### Application Example 2

In the exercise analysis device according to the application example, the motion detection unit may use detection data of an angular velocity of an axis at which the angular velocity generated by the radial deviation or the ulnar deviation of the wrist of the user is relatively larger than the angular velocities of the other axes among the detection data of the angular velocities generated around the plurality of axes.

In the exercise analysis device according to this application example, the detection data in which the angular velocity generated by the radial deviation or the ulnar deviation of the wrist of the user is relatively larger than the other detection data is used among the detection data of the angular velocities generated around the plurality of axes. Therefore, it is possible to detect the motion of the swing exercise with high accuracy.

### Application Example 3

An exercise analysis device according to this application example includes: a data acquisition unit that acquires detection data of angular velocities generated around a plurality of axes in a swing exercise of a user; and a motion detection unit that detects a motion of the swing exercise using, among the detection data, detection data of an angular velocity of an axis at which a change amount of angular velocity relatively larger than the angular velocities of the other axes when a direction of a swing is switched in the swing exercise.

In the exercise analysis device according to this application example, by noting that the angular velocity is necessarily generated by rotation and the change amount of angular velocity is large at the time of switching of the direction of the swing, the detection data in which the change amount of angular velocity is relatively larger than the other detection data at the time of switching of the direction of the swing is used among the detection data of the angular velocities generated around the plurality of axes. Therefore, it is possible to detect the timing at which the direction of the swing is switched in the swing exercise with high accuracy.

### Application Example 4

In the exercise analysis device according to the application example, the motion detection unit may detect a timing of an impact in the swing exercise based on the detection data used to detect a motion and detect a motion of the swing exercise using the timing of the impact as a criterion.

In the exercise analysis device according to this application example, the timing of the impact easily detected based on the detection data used to detect the motion is set as the criterion by noting that the angular velocity is sharply changed immediately after the impact in the swing exercise. Therefore, it is possible to reduce a concern of erroneous detection of other motions.

### Application Example 5

In the exercise analysis device according to the application example, the motion detection unit may differentiate the angular velocity of the detection data used to detect a motion of the swing exercise and detect a timing of the impact based on the differential result.

In the exercise analysis device according to this application example, the change amount of the angular velocity is clear as a numerical value by calculating the differential of the angular velocity of the detection data used to detect the motion. Therefore, it is possible to detect the timing of the impact more accurately.

### Application Example 6

In the exercise analysis device according to the application example, the motion detection unit may detect a portion in which positive and negative values of the angular velocity are switched before a timing of the impact as a timing of a top of the swing exercise.

It is considered that the motion is temporarily stopped at the top of the swing exercise after starting of the swing exercise, the positive and negative values of the angular velocity are switched, and subsequently the angular velocity gradually increases to reach the impact. Accordingly, in the exercise analysis device according to this application example, the timing at which the positive and negative values of the angular velocity are switched before the timing of the impact can be captured as the timing of the top of the swing exercise.

### Application Example 7

In the exercise analysis device according to the application example, the motion detection unit may detect a portion in which the angular velocity is equal to or less than a predetermined threshold value before the timing of the top as a timing of start of the swing exercise.

In the exercise analysis device according to this application example, when the exercise is not stopped until the top after the start of the swing exercise, the timing at which the angular velocity is equal to or less than the predetermined threshold value before the timing of the top can be captured as the timing of the start of the swing exercise.

### Application Example 8

In the exercise analysis device according to the application example, the motion detection unit may detect a portion in which the angular velocity is equal to or less than a predetermined threshold value after the timing of the impact as a timing of end of the swing exercise.

In the exercise analysis device according to this application example, when the angular velocity gradually decreases after the impact and the swing exercise is stopped, the timing at which the angular velocity is equal to or less than the predetermined threshold value after the timing of the impact can be captured as the timing of the end of the swing exercise.

### Application Example 9

An exercise analysis system according to this application example includes: any of the exercise analysis devices described above; and a sensor that generates detection data.

The sensor may be, for example, an inertial sensor. The inertial sensor is, for example, a sensor capable of measuring at least one of inertial amounts such as acceleration and angular velocities. For example, the inertial sensor may be an acceleration sensor, may be an angular velocity sensor, may be an inertial measurement unit (IMU) capable of measuring acceleration and an angular velocity. For example, the sensor may be fitted on a portion of an exercise tool or a user or may be detachably mounted on an exercise tool or a user. For example, the sensor may be built in an exercise tool to be fixed to the exercise tool so that the sensor is not detachable. The exercise tool may be, for example, a tool such as a golf club, a tennis racket, a baseball bat, or a hockey stick.

In the exercise analysis system according to this application example, the exercise analysis device can detect the motion of the swing exercise of the user more accurately and suggest the information based on the detection result.

### Application Example 10

An exercise analysis method according to this application example includes: acquiring detection data of angular velocities generated around a plurality of axes in a swing exercise of a user; and detecting a motion of the swing exercise using detection data of an angular velocity generated by radial deviation or ulnar deviation of a wrist of the user among the detection data.

In the exercise analysis method according to this application example, the motion of the swing exercise is detected using the detection data of each angular velocity generated around the plurality of axes, unlike a method of the related art that a motion of a swing exercise is detected using detection data of acceleration, by noting that an angular velocity is necessarily generated by rotation and a change amount of angular velocity is large at the time of switching of a swing in a swing exercise. Accordingly, in the exercise analysis method according to this application example, it is possible to detect the motion in the swing exercise more accurately than the method of the related art.

In the exercise analysis method according to this application example, it is possible to detect the motion of the swing exercise with high accuracy using the angular velocity generated by radial deviation or ulnar deviation of a wrist of a user in the swing exercise of the user.

### Application Example 11

An exercise analysis method according to this application example includes: acquiring detection data of angular velocities generated around a plurality of axes in a swing exercise of a user; and detecting a motion of the swing exercise using, among the detection data, detection data of an angular velocity of an axis at which a change amount of angular velocity relatively larger than the angular velocities of the other axes when a direction of a swing is switched in the swing exercise.

In the exercise analysis method according to this application example, by noting that the angular velocity is necessarily generated by rotation and the change amount of angular velocity is large at the time of switching of the direction of the swing, the detection data in which the change amount of angular velocity is relatively larger than the other detection data at the time of switching of the direction of the swing is used among the detection data of the angular velocities generated around the plurality of axes. Therefore, it is possible to detect the timing at which the direction of the swing is switched in the swing exercise with high accuracy.

### Application Example 12

A program according to this application example causes a computer to perform: acquiring detection data of angular velocities generated around a plurality of axes in a swing exercise of a user; and detecting a motion of the swing exercise using detection data of an angular velocity generated by radial deviation or ulnar deviation of a wrist of the user among the detection data.

By noting that an angular velocity is necessarily generated by rotation and a change amount of angular velocity is large at the time of switching of a swing in a swing exercise, the program according to this application example detects the motion of the swing exercise using the detection data of each angular velocity generated around the plurality of axes, unlike a program of the related art that detects a motion of a swing using detection data of acceleration. Accordingly, in the program according to this application example, it is possible to detect the motion in the swing exercise more accurately than the program of the related art.

In the program according to this application example, it is possible to detect the motion of the swing exercise with high accuracy using the angular velocity generated by radial deviation or ulnar deviation of a wrist of a user in the swing exercise of the user.

### Application Example 13

A program according to this application example causes a computer to perform: acquiring detection data of angular velocities generated around a plurality of axes in a swing exercise of a user; and detecting a motion of the swing exercise using, among the detection data, detection data of an angular velocity of an axis at which a change amount of angular velocity relatively larger than the angular velocities of the other axes when a direction of a swing is switched in the swing exercise.

In the program according to this application example, by noting that the angular velocity is necessarily generated by rotation and a change amount of angular velocity is large at the time of switching of the direction of a swing in a swing exercise, the detection data in which the change amount of angular velocity is relatively larger than the other detection data at the time of switching of the direction of the swing is used of the detection data of the angular velocities generated around the plurality of axes. Therefore, it is possible to detect the timing at which the direction of the swing is switched in the swing exercise with high accuracy.

### BRIEF DESCRIPTION OF THE DRAWINGS

The invention will be described with reference to the accompanying drawings, wherein like numbers reference like elements.

FIG. 1 is a diagram illustrating an overview of an exercise analysis system according to an embodiment.

FIG. 2 is a diagram illustrating an example of a mounted position and a direction of a sensor unit.

FIG. 3 is a diagram illustrating a procedure of a motion performed by a user according to the embodiment.

FIG. 4 is a diagram illustrating an example of a screen displayed on a display unit of an exercise analysis device.

FIG. 5 is a diagram illustrating a configuration example of the exercise analysis system according to the embodiment.

FIG. 6A is a diagram illustrating radial deviation and ulnar deviation.

FIG. 6B is a diagram illustrating an example of a relation between a rotation axis of a radial deviation direction and an ulnar deviation direction and a detection axis of the sensor unit.

FIG. 7A is a diagram illustrating an example of detection data of an x axis angular velocity at the time of swing.

FIG. 7B is a diagram illustrating an example of detection data of a y axis angular velocity at the time of swing.

FIG. 7C is a diagram illustrating an example of detection data of a z axis angular velocity at the time of swing.

FIG. 8 is a flowchart illustrating a procedure example of an analysis process for a swing exercise according to the embodiment.

FIG. 9 is a flowchart illustrating a procedure example of a process of detecting each motion in a swing.

FIG. 10A is a diagram illustrating a graph of the x axis angular velocity at the time of swing.

FIG. 10B is a diagram illustrating a graph of a differential value of the x axis angular velocity of FIG. 10A.

FIG. 10C is an enlarged diagram illustrating the vicinity of an impact of FIG. 10B.

FIG. 11 is flowchart illustrating a procedure example of an analysis process of a swing rhythm and a swing tempo.

### DESCRIPTION OF EXEMPLARY EMBODIMENTS

Hereinafter, preferred embodiments of the invention will be described in detail with reference to the drawings. Embodiments to be described below do not inappropriately limit content of the invention described in the appended claims. All of the constituent elements to be described below may not be necessarily requisite constituent elements.

Hereinafter, an exercise analysis system (swing analysis system) performing analysis of a golf swing will be described as an example. A golf swing exercise is an exercise in which the head of a golf club is rotationally moved from the position at the time of address to the position of a top and is further rotationally moved from the position of the top to pass through the position of an impact (a position close to the position at the time of address) and is a rotational reciprocation exercise involving rotation and reciprocation. The embodiments to be described below are not limited to swing exercises of golf, but can also be applied to various rotational reciprocation exercises of swing exercises of tennis or baseball.

### 1. Exercise Analysis System

### 1-1. Overview of Exercise Analysis System

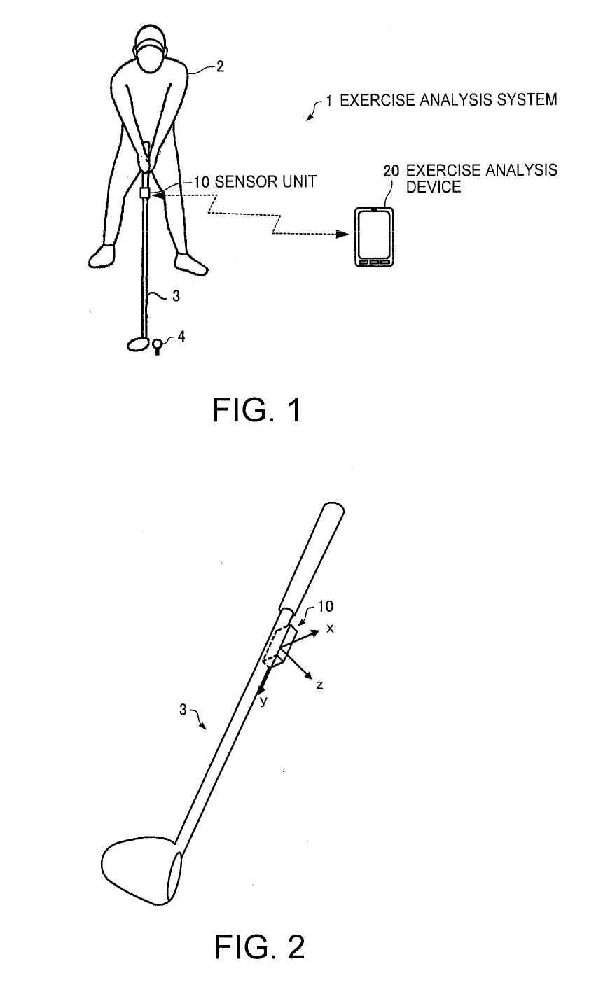

FIG. 1 is a diagram illustrating an overview of the exercise analysis system according to an embodiment. An exercise analysis system 1 according to the embodiment is configured to include a sensor unit 10 (which is an example of a sensor) and an exercise analysis device 20.

The sensor unit 10 can measure acceleration generated in each axis direction of three axes and an angular velocity generated at each axis rotation of the three axes and is mounted on the golf club 3 (which is an example of an exercise tool).

In the embodiment, as illustrated in FIG. 2, the sensor unit 10 is fitted on a part of the shaft of a golf club 3 when one axis among three detection axes (the x axis, the y axis, and the z axis), for example, the y axis conforms with the longitudinal direction of the shaft. Preferably, the sensor unit 10 is fitted at a position close to a grip in which a shock at the time of hitting is rarely delivered and a centrifugal force is not applied at the time of swing. The shaft is a portion of the handle excluding the head of the golf club 3 and also includes the grip.

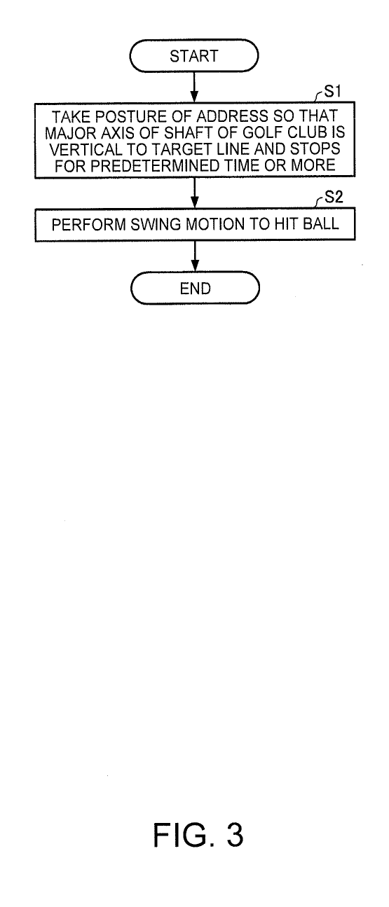

A user 2 performs a swing motion of hitting a golf ball 4 in a pre-decided procedure. FIG. 3 is a diagram illustrating a procedure of a motion performed by the user 2. As illustrated in FIG. 3, the user 2 first holds the golf club 3, takes a posture of address so that the major axis of the shaft of the golf club 3 is vertical to a target line (target direction of hitting), and stops for a predetermined time or more (for example, 1 second or more) (S1). Next, the user 2 performs a swing motion to hit the golf ball 4 (S2).

While the user 2 performs the motion to hit the golf ball 4 in the procedure illustrated in FIG. 3, the sensor unit measures triaxial acceleration and triaxial angular velocity at a predetermined period (for example, 1 ms) and sequentially transmits the measurement data to the exercise analysis device 20. The sensor unit 10 may immediately transmit the measurement data, or may store the measurement data in an internal memory and transmit the measurement data at a predetermined timing such as end of a swing motion of the user 2. Communication between the sensor unit 10 and the exercise analysis device 20 may be wireless communication or wired communication. Alternatively, the sensor unit 10 may store the measurement data in a recording medium such as a memory card which can be detachably mounted and the exercise analysis device 20 may read the measurement data from the recording medium.

The exercise analysis device 20 analyzes a swing exercise in which the user 2 performs hitting with the golf club 3 by using the data measured by the sensor unit 10. In particular, in the embodiment, the exercise analysis device 20 acquires measurement data (which is an example of detection data of each angular velocity generated around a plurality of axes in a swing exercise) including information regarding angular velocity around three axes measured by the sensor unit 10 and detects a motion of a swing exercise using the acquired measurement data. Then, the exercise analysis device 20 analyzes a swing rhythm or tempo based on the detected motion and draws information regarding the analysis result in a display unit (display). The exercise analysis device 20 may be, for example, a portable device such as a smartphone or a personal computer (PC).

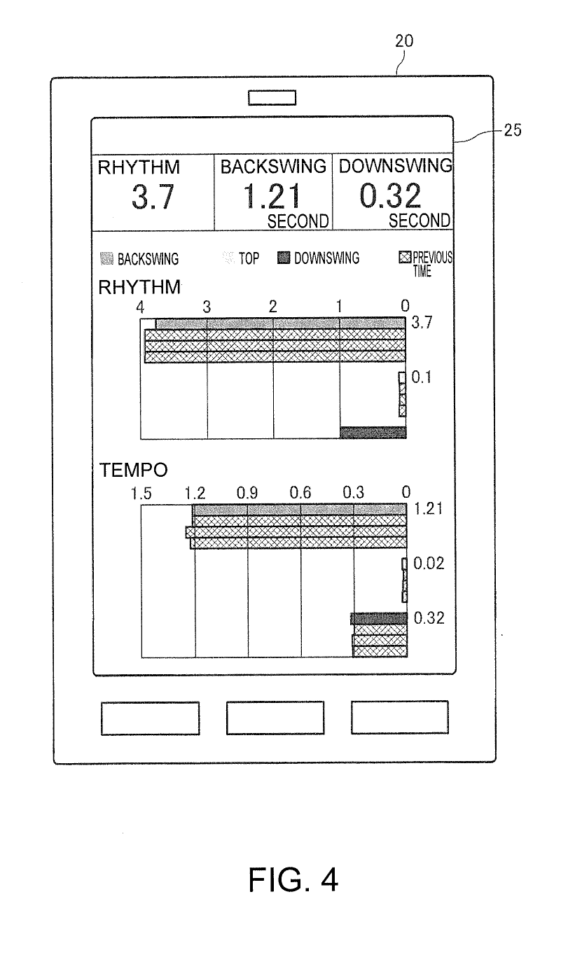

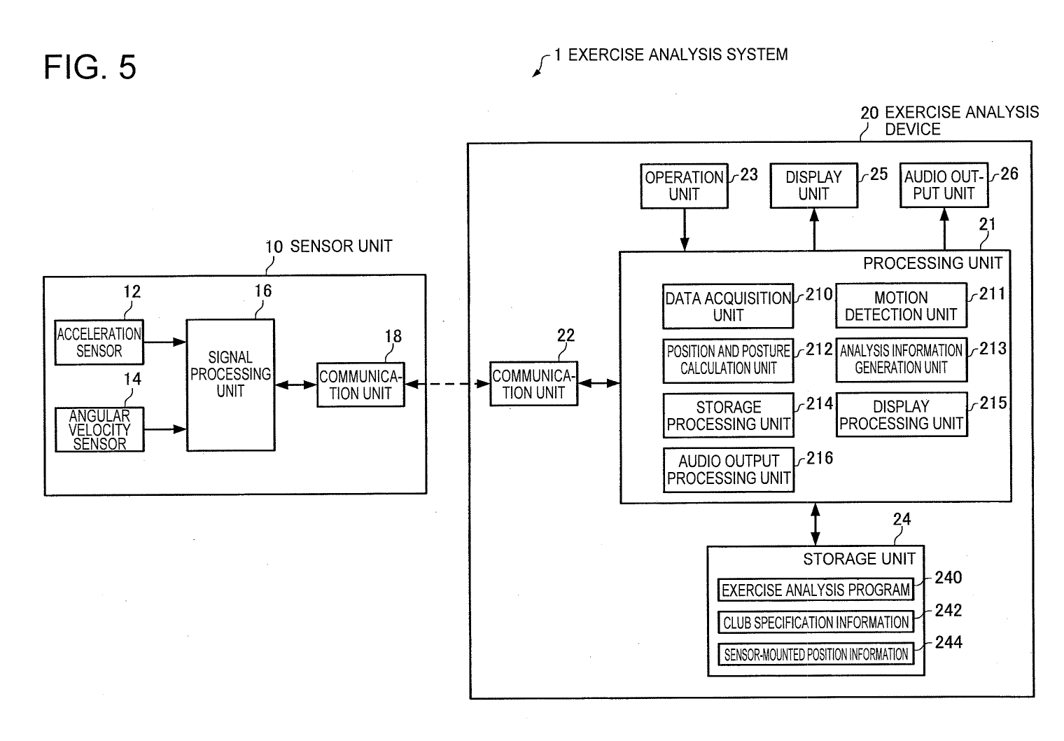

FIG. 4 is a diagram illustrating an example of a screen displayed on a display unit 25 (see FIG. 5) of the exercise analysis device 20. The screen illustrated in FIG. 4 includes information regarding analysis results of swing rhythms including a ratio (the time of a backswing/the time of a downswing) of the time of a backswing time to the time of a downswing and a ratio (the time of a top section/the time of a downswing) of the time of a top section (the time of accumulation in the top section) to the time of a downswing at each swing of a recent swing and swings of a plurality of times (for example, immediately previous 3 times) up to the previous swing. The screen illustrated in FIG. 4 further includes information regarding analysis results of swing tempos including the time of a backswing, the time of the top section (the time of accumulation at the top), and the time of a downswing at each swing of a recent swing and swings of a plurality of times (for example, immediately previous 3 times) up to the previous swing. When the user 2 confirms the analysis information regarding the swing rhythms or the swing tempos updated at each time of performing a swing and takes exercise being conscious of performing a swing at the same rhythm or tempo every time, the user can acquire astable swing suitable for the user.

### 1-2. Configuration of Exercise Analysis System

FIG. 5 is a diagram illustrating a configuration example of the exercise analysis system 1 (a configuration example of the sensor unit 10 and the exercise analysis device 20) according to the embodiment. As illustrated in FIG. 5, in the embodiment, the sensor unit 10 includes an acceleration sensor 12, an angular velocity sensor 14, a signal processing unit 16, and a communication unit 18.

The acceleration sensor 12 measures acceleration generated in each of mutually intersecting (ideally, orthogonal) triaxial directions and outputs digital signals (acceleration data) according to the sizes and directions of the measured triaxial accelerations.

The angular velocity sensor 14 measures an angular velocity generated at each axis rotation of mutually intersecting (ideally, orthogonal) triaxial directions and outputs digital signals (angular velocity data) according to the sizes and directions of the measured triaxial angular velocities.

The signal processing unit 16 receives the acceleration data and the angular velocity data from the acceleration sensor 12 and the angular velocity sensor 14, appends time information, and stores the acceleration data and the angular velocity data in a storage unit (not illustrated). The signal processing unit 16 generates packet data in conformity to a communication format by appending time information to the stored measurement data (the acceleration data and the angular velocity data) and outputs the packet data to the communication unit 18.

The acceleration sensor 12 and the angular velocity sensor 14 are ideally fitted in the sensor unit 10 so that the three axes of each sensor match the three axes (the x axis, the y axis, and the z axis) of the rectangular coordinate system (sensor coordinate system) defined for the sensor unit 10, but errors of the fitting angles actually occur. Accordingly, the signal processing unit 16 performs a process of converting the acceleration data and the angular velocity data using correction parameters calculated in advance according to the errors of the fitting angles into data of the xyz coordinate system.

The signal processing unit 16 may perform a temperature correction process on the acceleration sensor 12 and the angular velocity sensor 14. Alternatively, a temperature correction function may be embedded in the acceleration sensor 12 and the angular velocity sensor 14.

The acceleration sensor 12 and the angular velocity sensor 14 may output analog signals. In this case, the signal processing unit 16 may perform A/D conversion on each of an output signal of the acceleration sensor 12 and an output signal of the angular velocity sensor 14, generate measurement data (acceleration data and angular velocity data), and generate packet data for communication using the measurement data.

The communication unit 18 performs, for example, a process of transmitting the packet data received from the signal processing unit 16 to the exercise analysis device 20 or a process of receiving control commands from the exercise analysis device 20 and transmitting the control commands to the signal processing unit 16. The signal processing unit 16 performs various processes according to the control commands.

The exercise analysis device 20 includes a processing unit 21, a communication unit 22, an operation unit 23, a storage unit 24, a display unit 25, and an audio output unit 26.

The communication unit 22 performs, for example, a process of receiving the packet data transmitted from the sensor unit 10 and transmitting the packet data to the processing unit 21 or a process of transmitting a control command from the processing unit 21 to the sensor unit 10.

The operation unit 23 performs a process of acquiring operation data from the user 2 and transmitting the operation data to the processing unit 21. The operation unit 23 may be, for example, a touch panel type display, a button, a key, or a microphone.

The storage unit 24 is configured as, for example, any of various IC memories such as a read-only memory (ROM), a flash ROM, and a random access memory (RAM) or a recording medium such as a hard disk or a memory card.

The storage unit 24 stores, for example, programs used for the processing unit 21 to perform various calculation processes or control processes, or various program or data used for the processing unit 21 to realize application functions. In particular, in the embodiment, the storage unit 24 stores an exercise analysis program 240 which is read by the processing unit 21 to perform an analysis process for a swing exercise of the user 2. The exercise analysis program 240 may be stored in advance in a nonvolatile recording medium. Alternatively, the exercise analysis program 240 may be received from a server via a network by the processing unit 21 and may be stored in the storage unit 24.

In the embodiment, the storage unit 24 stores club specification information 242 indicating the specification of the golf club 3 and sensor-mounted position information 244. For example, the user 2 operates the operation unit 23 to input a model number of the golf club 3 (or select the model number from a model number list) and set specification information regarding the input model number as the specification information 242 among pieces of specification information for each model number (for example, information regarding the length of a shaft, the position of center of gravity, a lie angle, a face angle, a loft angle, and the like) stored in advance in the storage unit 24. For example, the user 2 operates the operation unit 23 to input a distance between a mounted position of the sensor unit 10 and the grip of the golf club 3, and information regarding the input distance is stored as sensor-mounted position information 244 in the storage unit 24. Alternatively, by mounting the sensor unit 10 at a decided predetermined position (for example, a distance of 20 cm from the grip), information regarding the predetermined position may be stored in advance as the sensor-mounted position information 244.

The storage unit 24 is used as a work area of the processing unit 21 and temporarily stores, for example, data input from the operation unit 23 and calculation results performed according to various programs by the processing unit 21. The storage unit 24 may store data necessarily stored for a long time among the data generated through the processes of the processing unit 21.

The display unit 25 displays a processing result of the processing unit 21 as text, a graph, a table, animations, or another image. The display unit 25 may be, for example, a CRT, an LCD, a touch panel type display, or a head-mounted display (HMD). The functions of the operation unit 23 and the display unit 25 may be realized by one touch panel type display.

The audio output unit 26 outputs a processing result of the processing unit 21 as audio such as a voice or a buzzer sound. The audio output unit 26 may be, for example, a speaker or a buzzer.

The processing unit 21 performs a process of transmitting a control command to the sensor unit 10, various calculation processes on data received from the sensor unit 10 via the communication unit 22, and other various control processes according to various programs. In particular, in the embodiment, the processing unit 21 performs the exercise analysis program 240 to function as a data acquisition unit 210, a motion detection unit 211, a position and posture calculation unit 212, an analysis information generation unit 213, a storage processing unit 214, a display processing unit 215, and an audio output processing unit 216.

The data acquisition unit 210 performs processes of receiving the packet data received from the sensor unit 10 by the communication unit 22, acquiring the time information and the measurement data (including detection data (triaxial angular velocity data) of angular velocities generated around the three axes and detection data (triaxial acceleration data) of acceleration generated in the triaxial directions in a swing exercise) from the received packet data, and transmitting the detection data to the storage processing unit 214.

The storage processing unit 214 performs processes of receiving the time information and the measurement data from the data acquisition unit 210 and storing the time information and the measure data in the storage unit 24 in association therewith.

The motion detection unit 211 performs a process of detecting a timing (a measurement time of the measurement data) of each motion in the swing exercise of the user 2 using the measurement data output by the sensor unit 10.

Since a rotation axis (which is an axis vertical to a swing plane) of a swing from a backswing to a downswing is close to parallel to a rotation axis of a radial deviation direction and an ulnar deviation direction of the wrist of the user 2, it is easy to specify a timing of each motion in a swing motion from a change in an angular velocity generated around the rotation axis of the radial deviation direction and the ulnar deviation direction of the wrist. Accordingly, in the embodiment, the motion detection unit 211 detects a motion of a swing exercise using detection data of an angular velocity generated by radial deviation or ulnar deviation of the wrist of the user 2 among the pieces of detection data of the angular velocities generated around the three axes in the swing exercise.

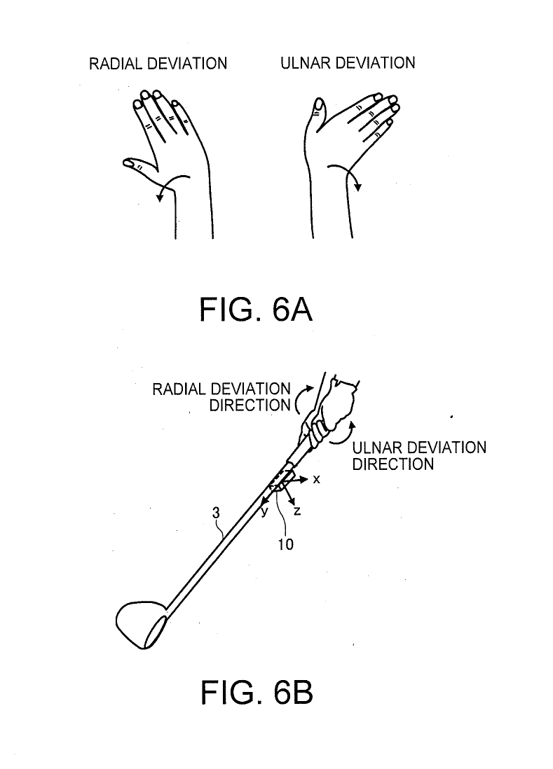

As illustrated in FIG. 6A, radial deviation is a motion of bending a wrist toward a thumb and ulnar deviation is a motion of bending a wrist toward a little finger. Accordingly, a radial deviation direction is a rotational direction (a rotational direction of counterclockwise rotation in FIG. 6A) in a motion of bending a wrist toward a thumb and an ulnar deviation direction is a rotational direction (a rotational direction of clockwise rotation in a plan view on the side of the back of a hand) in a motion of bending a wrist toward the side of a little finger.

The motion detection unit 211 may use the detection data of which the angular velocity generated by radial deviation or ulnar deviation of the wrist of the user 2 is relatively larger than that of the other detection data among the detection data of the angular velocities generated around the three axes. In particular, the motion detection unit 211 may use the detection data of an axis at which a detected value of an angular velocity generated around the rotation axis of the radial deviation direction and the ulnar deviation direction of the wrist is the largest among the three axes, in other words, an axis at which an angle formed with the rotation axis of the radial deviation direction and the ulnar deviation direction of the wrist is the smallest.

When the user 2 correctly holds the grip of the golf club 3, the rotation axis of the radial deviation direction and the ulnar deviation direction of the wrist has a relation substantially vertical to a face plane (hitting plane) of the head of the golf club 3. Accordingly, it can be said that the motion detection unit 211 may use the detection data of an axis at which a detected value of an angular velocity generated around the axis vertical to the face plane of the head of the golf club 3 is the largest among the three axes, in other words, an axis at which the angle formed with the axis vertical to the face plane is the smallest.

When the user 2 correctly holds the grip of the golf club 3 in an address state and takes a square, a target line (target hitting direction) has a relation substantially vertical to the face plane of the head of the golf club 3, in other words, a relation substantially parallel to the rotation axis of the radial deviation direction and the ulnar deviation direction of the wrist. Accordingly, it can be said that the motion detection unit 211 may use the detection data of the axis which is closest to the target line in the address state among the three axes before the user 2 starts a swing exercise.

In this way, at the time of the top at which a swing is switched from the backswing to the downswing, a change amount of angular velocity generated around at least one axis among the three axes is larger than a change amount of angular velocity generated around at least another axis among the three axes. Therefore, the motion detection unit 211 can also specify a timing of each motion in the swing exercise using only the detection data of some axes.

For example, the motion detection unit 211 can detect a motion of a swing exercise using only one axis which is closest to the rotation axis of the radial deviation direction and the ulnar deviation direction of the wrist of the user 2 among the x axis, the y axis, and the z axis or can also detect a motion of a swing exercise using two axes, that is, the axis which is closest to the rotation axis and the axis which is the second closest to the rotation axis. For example, as illustrated in FIG. 2, when the sensor unit 10 is fitted so that the y axis matches the major axis direction of the shaft and a restriction is provided such that the sensor unit 10 is fitted so that the x axis is substantially vertical to the face plane of the head of the golf club 3 (the user 2 performs the motion of S1 of FIG. 3 so that the x axis at the time of the address is substantially parallel to the target line), as illustrated in FIG. 6B, the x axis is substantially parallel to the rotation axis of the radial deviation direction and the ulnar deviation direction of the wrist of the user 2 and the y and z axes are substantially vertical to the rotation axis. Accordingly, in this case, since the change amount of the angular velocity around the x axis is large particularly at the top of the swing, the motion detection unit 211 may select only the x axis as the axis used to detect a motion of a swing exercise. On the other hand, when the sensor unit 10 is fitted so that the y axis matches the major axis direction of the shaft and a restriction is not provided in the x and z axis directions, the y axis is substantially vertical to the rotation axis of the radial deviation direction and the ulnar deviation direction of the wrist of the user 2. Therefore, in particular, the change amount of angular velocity around the y axis at the top of a swing is small, but a magnitude relation between the change amount of angular velocity around the x axis and the change amount of angular velocity around the z axis is not known. Accordingly, in this case, the motion detection unit 211 may select two axes, that is, the x and z axes as the axes used to detect a motion of a swing exercise.

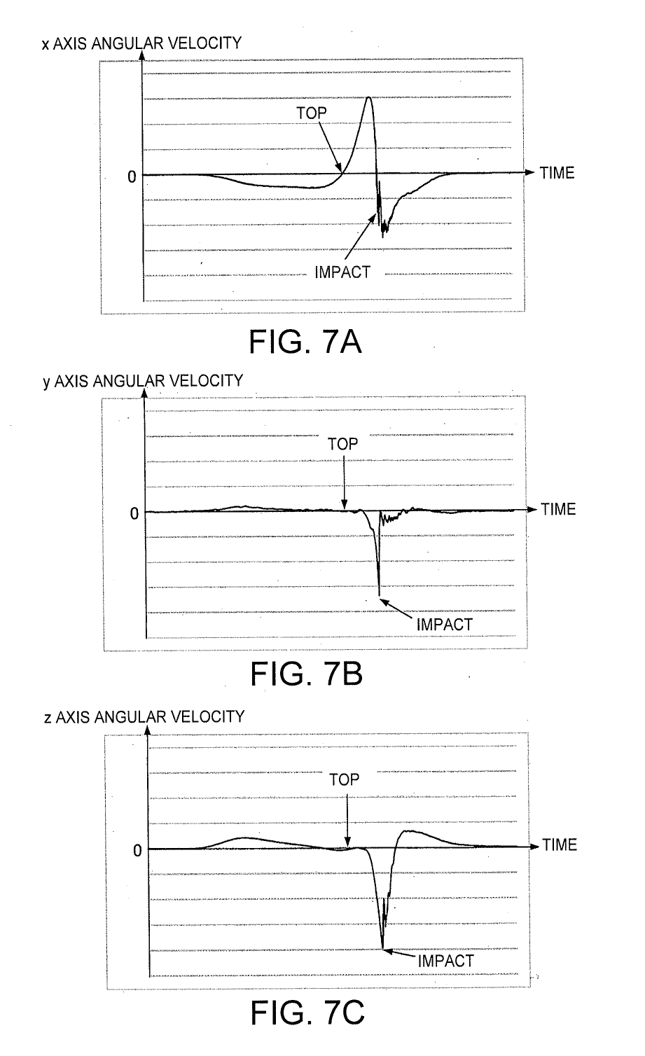

FIGS. 7A, 7B, and 7C are diagrams illustrating examples of the detection data (actually measured values) of the angular velocities around the x axis, the y axis, and the z axis during a swing exercise, respectively. In FIGS. 7A, 7B, and 7C, the horizontal axis represents a time and the vertical axis represents an angular velocity. For all of the three axes, the change amounts of angular velocities are large near an impact. The change amount of the angular velocity around the x axis which is closest to the rotation axis of the radial deviation direction and the ulnar deviation direction of the wrist is large near the top, but the change amount of angular velocity around the z axis at which a difference from the rotation axis is large is small and the angular velocity around the y axis substantially vertical to the rotation axis is zero, and thus is rarely changed. Accordingly, in order to accurately detect the top of a swing, it is sufficient to use only the angular velocity around the x axis or use a combination value of the angular velocity around the x axis and the angular velocity around the z axis. Even in this case, a calculation amount can be reduced further than when a combination value of the three axes is used.

The motion detection unit 211 may detect a timing (time t₅) of an impact in a swing exercise based on the detection data used to detect a motion and detect the motion of the swing exercise using the timing of the impact as a criterion. The motion detection unit 211 may detect a motion of the swing exercise using the value of an angular velocity around one axis (for example, the x axis) when the detection data used to detect the motion is only the detection data of the one axis among the three axes, and may detect a motion of the swing exercise using a composite value of the angular velocities around a plurality of axes (for example, the x and y axes) when the detection data used to detect the motion is the detection data of the plurality of axes.

The motion detection unit 211 may differentiate an angular velocity of the detection data used to detect a motion and detect a timing of an impact based on the differential result. The motion detection unit 211 may detect the timing of the impact using the differential value of the angular velocity around one axis (for example, the x axis) when the detection data used to detect the motion is only the detection data of the one axis among the three axes, and may detect the timing of the impact using the differential value of a composite value of the angular velocities around a plurality of axes (for example, the x and y axes) when the detection data used to detect the motion is the detection data of the plurality of axes. Here, a square root of a sum of the squares of the angular velocities round the axes, a sum of the squares of the angular velocities around the axes, a sum or an average value of the angular velocities around the axes, or a product of the angular velocities around the axes may be used as the composite value.

The motion detection unit 211 may detect a timing (time t₃) at which positive and negative values of the angular velocity (a composite value of the angular velocities at the time of the angular velocities around the plurality of axes) of the detection data used to detect a motion are switched before the timing (time t₅) of the impact as a timing at which a rotation direction is changed in the swing exercise, that is, as a timing of the top at which a swing is switched from a backswing to a downswing.

The motion detection unit 211 may specify a section (from start time t₂ to end time t₄) in which the angular velocity (a composite value of the angular velocities at the time of the angular velocities around the plurality of axes) of the detection data used to detect a motion is continuously equal to less than a predetermined first threshold value D₁ before the timing (time t₅) of the impact as a section of the top.

The motion detection unit 211 may detect a portion (for example, time t₁) in which the angular velocity (a composite value of the angular velocities at the time of the angular velocities around the plurality of axes) of the detection data used to detect a motion that is equal to or less than a predetermined second threshold value D₂ before the timing of the top (start time t₂ of the top section) as a timing of start of the swing exercise.

The motion detection unit 211 may detect a portion (for example, time t₆) in which the angular velocity (a composite value of the angular velocities at the time of the angular velocities around the plurality of axes) of the detection data used to detect a motion that is to be equal to less than a predetermined third threshold value D₃ after the timing (time t₅) of the impact as a timing of end of the swing exercise.

The motion detection unit 211 may detect a series of motions, the start of the swing exercise, a backswing, a top, a downswing, an impact, a follow-through, and the end of the swing exercise.

An example of the procedure of a specific process of the motion detection unit 211 will be described below.

The position and posture calculation unit 212 calculates the position and the posture (posture angle) of the sensor unit 10 in the swing exercise using measurement data (detection data of acceleration in the triaxial direction and detection data of the angular velocities around the three axes) output by the sensor unit 10. For example, an XYZ coordinate system (global coordinate system) may be defined such that a target line indicating a target hitting direction is the X axis, an axis on a horizontal plane vertical to the X axis is the Y axis, and an upward perpendicular direction (which is an opposite direction to the direction of the acceleration of gravity) is the Z axis, and the position and posture calculation unit 212 may calculate the position and the posture of the sensor unit 10 in the XYZ coordinate system.

Specifically, the position and posture calculation unit 212 first calculates an offset amount included in the measurement data using the measurement data (the acceleration data and the angular velocity data) at the time of stop (the time of address) of the user 2 stored in the storage unit 24. Next, the position and posture calculation unit 212 subtracts the offset amount from the measurement data after start of a swing stored in the storage unit 24, corrects a bias, and calculates the position and the posture (posture angle) of the sensor unit 10 during the swing exercise (during the motion of step S2 of FIG. 3) of the user 2 using the measurement data in which the bias is corrected.

For example, the position and posture calculation unit 212 calculates the position (initial position) of the sensor unit 10 at the time of stop (the time of address) of the user 2 in the XYZ coordinate system (global coordinate system) using the acceleration data measured by the acceleration sensor 12, the club specification information 242, and the sensor-mounted position information 244 and integrates the subsequent acceleration data to chronologically calculate a change in the position from the initial position of the sensor unit 10.

Since the user 2 performs the motion of step S1 of FIG. 3, the X coordinate of the initial position of the sensor unit 10 is 0. As illustrated in FIG. 2, since the y axis of the sensor unit 10 matches the major axis direction of the shaft of the golf club 3 and the acceleration sensor 12 measures only the acceleration of gravity when the user 2 stops, the position and posture calculation unit 212 can calculate an inclination angle (which is an inclination with respect to the horizontal plane (XY plane) or the vertical plane (the XZ plane)) of the shaft using y axis acceleration data. Then, the position and posture calculation unit 212 obtains a distance L_{SH} from the club specification information 242 (the length of the shaft) and the sensor-mounted position information 244 (a distance from the grip) to the head of the sensor unit 10 and uses, for example, the position of the head as the origin (0, 0, 0) to set a position distant by the distance L_{SH} from the origin in the negative direction of the y axis of the sensor unit 10 specified by the inclination angle of the shaft to the initial position of the sensor unit 10.

The position and posture calculation unit 212 calculates a posture (initial posture) of the sensor unit 10 at the time of stop (the time of address) of the user 2 in the XYZ coordinate system (global coordinate system) using the acceleration data measured by the acceleration sensor 12 and performs rotation calculation using the angular velocity data subsequently measured by the angular velocity sensor 14 to chronologically calculate a change in the posture from the initial posture of the sensor unit 10. The posture of the sensor unit 10 can be expressed by, for example, rotation angles (a roll angle, a pitch angle, and a yaw angle) around the X axis, the Y axis, and the Z axis, quaternion, or the like. At the time of stop of the user 2, the acceleration sensor 12 measures only the acceleration of gravity. Therefore, the position and posture calculation unit 212 can specify an angle formed between of each of the x, y axis, and z axes of the sensor unit 10 and a gravity direction using the triaxial acceleration data. Since the user 2 performs the motion of step S1 of FIG. 3, the y axis of the sensor unit 10 is present on the YZ plane at the time of stop of the user 2. Therefore, the position and posture calculation unit 212 can specify the initial posture of the sensor unit 10.

The signal processing unit 16 of the sensor unit 10 may calculate the offset amount of the measurement data and correct the bias of the measurement data or the bias correction function may be embedded in the acceleration sensor 12 and the angular velocity sensor 14. In this case, it is not necessary to correct the bias of the measurement data by the position and posture calculation unit 212.

The analysis information generation unit 213 performs processes of analyzing the swing exercise of the user 2 using the motion detected by the motion detection unit 211 or the position and the posture of the sensor unit 10 calculated by the position and posture calculation unit 212 and generating analysis information which is the analysis result.

The analysis information generation unit 213 analyzes the rhythm or tempo of the swing from motions (for example, start of the swing exercise, a top, a top section, an impact, and end of the swing exercise) of the swing exercise and generates information which is the analysis result. Specifically, the analysis information generation unit 213 first calculates, for example, a time of the backswing, a time of the top section (an accumulation time at the top), a time of the downswing, and a time of the follow-through from the motions of the swing exercise. The time of the backswing is calculated from time t₃ of the top to start time t₁ of the swing exercise. The time of the top section is calculated from end time t₄ of the top section to start time t₂ of the top section. The time of the downswing is calculated from time t₅ of the impact to time t₃ of the top. The time of the follow-through is calculated from end time t₆ of the swing exercise to time t₅ of the impact.

Then, the analysis information generation unit 213 generates information (for example, information regarding the swing tempo included in the screen of FIG. 4) regarding the swing tempo including information regarding some or all of the time of backswing, the time of the top section, the time of the downswing, and the time of the follow-through.

The analysis information generation unit 213 may calculate a ratio (the time of the backswing/the time of the downswing) of the time of the backswing to the time of the downswing and a ratio (the time of the top section/the time of the downswing) of the time of the top section (the accumulation time at the top) to the time of the downswing and may generate information (for example, information regarding the swing rhythm included in the screen of FIG. 4) regarding the swing rhythm including information regarding the ratios.

For example, the analysis information generation unit 213 may chronologically calculate the position of the head or the grip of the golf club 3 in the swing exercise of the user 2 and generate information regarding a trajectory of the golf club 3 (a trajectory of the head or the grip) based on the calculation result. Specifically, the analysis information generation unit 213 sets a position distant by the distance L_{SH} in the positive direction of the y axis of the sensor unit 10 specified by the posture of the sensor unit 10 at each time of the swing from the position of the sensor unit 10 at that time, as the position of the head at that time.

The analysis information generation unit 213 sets a position distant from the position of the sensor unit 10 at each time of a swing by a distance L_{SG} between the sensor unit 10 and the grip specified by the sensor-mounted position information 244 (a distance from the grip) in the negative direction of the y axis of the sensor unit 10 specified by the posture of the sensor unit 10 at that time, as the position of the grip at that time.

Then, the analysis information generation unit 213 performs a process of generating trajectory information (image data) of the golf club 3 for a predetermined time of the swing exercise using chronological information regarding the position of the head or the grip of the golf club 3. For example, the analysis information generation unit 213 may generate trajectory information including the trajectory of the head and the trajectory of the grip from the start of a swing to an impact by sequentially connecting the positions (coordinates) of the head from the start of the swing to the impact and sequentially connecting the positions (coordinates) of the grip from the start of the swing to the impact in a similar manner.

The analysis information generation unit 213 may further use the information regarding the position and the posture of the head or the grip to generate information regarding a head speed or a grip speed at the time of the impact, information regarding an angle of incidence (club pass) of the head, a face angle, or shaft rotation (a change amount of face angle during a swing) at the time of impact, information regarding a deceleration rate or the like of the head, information regarding a variation in each piece of information when the user 2 performs the swing a plurality of times.

The storage processing unit 214 performs a process of reading/writing various programs or various kinds of data from/on the storage unit 24. The storage processing unit 214 also performs not only a process of storing time information and the measurement data received from the data acquisition unit 210 in the storage unit 24 in association therewith but also a process of storing various kinds of information or the like calculated by the motion detection unit 211, the position and posture calculation unit 212, and the analysis information generation unit 213 in the storage unit 24.

The display processing unit 215 performs a process of displaying various images (images or the like corresponding to the analysis information generated by the analysis information generation unit 213) on the display unit 25. For example, the display processing unit 215 causes the display unit 25 to display the images corresponding to the analysis information generated by the analysis information generation unit 213 after end of the swing exercise of the user 2, automatically, or according to an input operation of the user 2. Alternatively, a display unit may be provided in the sensor unit 10, and the display processing unit 215 may transmit image data to the sensor unit 10 via the communication unit 22 and cause the display unit of the sensor unit 10 to display various images, text, or the like.

The audio output processing unit 216 performs a process of causing the audio output unit 26 to output various kinds of audio (including a voice and a buzzer sound). For example, the audio output processing unit 216 may read various kinds of information stored in the storage unit 24 and output audio or a voice for analysis of the swing exercise to the audio output unit 26 after end of the swing exercise of the user 2, automatically, or at the time of performing a predetermined input operation. Alternatively, an audio output unit may be provided in the sensor unit 10, and the audio output processing unit 216 may transmit various kinds of audio data or voice data to the sensor unit 10 via the communication unit 22 and cause the audio output unit of the sensor unit 10 to output various kinds of audio or voices.

A vibration mechanism may be provided in the exercise analysis device 20 or the sensor unit 10 and the vibration mechanism may also convert various kinds of analysis information into vibration information and suggest the vibration information to the user 2.

### 1-3. Process of Exercise Analysis Device

### Analysis Process for Swing Exercise

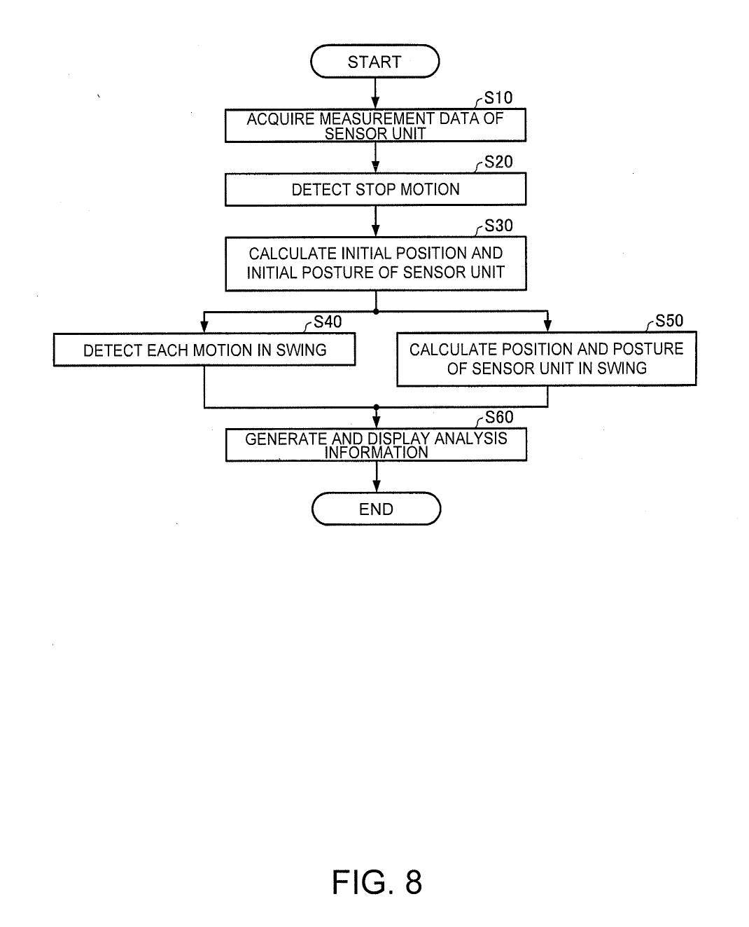

FIG. 8 is a flowchart illustrating the procedure of the analysis process for a swing exercise performed by the processing unit 21 of the exercise analysis device 20 according to the embodiment. The processing unit 21 of the exercise analysis device 20 (which is an example of a computer) executes the exercise analysis program 240 stored in the storage unit 24 to perform the exercise analysis process of a swing exercise in the procedure of the flowchart of FIG. 8. Hereinafter, the flowchart of FIG. 8 will be described.

First, the processing unit 21 acquires the measurement data of the sensor unit 10 (S10). In step S10, the processing unit 21 may perform processes subsequent to step S20 in real time when the processing unit 21 acquires the first measurement data in a swing (also including a stop motion) of the user 2 or may perform the processes subsequent to step S20 after the processing unit 21 acquires some or all of a series of measurement data in the swing exercise of the user 2 from the sensor unit 10.

Next, the processing unit 21 detects a stop motion (address motion) (the motion of step S1 of FIG. 3) of the user 2 using the measurement data acquired from the sensor unit 10 (S20). When the processing unit 21 performs the process in real time and detects the stop motion (address motion), for example, the processing unit 21 may output a predetermined image or audio, or an LED may provided in the sensor unit 10 and an LED may be turned on or off. Then, the user 2 is notified of detection of a stop state, and then the user 2 may start a swing after the user 2 confirms the notification.

Next, the processing unit 21 calculates the initial position and the initial posture of the sensor unit 10 using the measurement data (the measurement data in the stop motion (address motion) of the user 2) acquired from the sensor unit 10, the club specification information 242, the sensor-mounted position information 244, and the like (S30).

Next, the processing unit 21 detects each motion of the swing using the measurement data acquired from the sensor unit 10 (S40). A procedure example of the motion detection process will be described below.

The processing unit 21 calculates the position and the posture of the sensor unit 10 in the swing in parallel to, before, or after the process of step S40 using the measurement data acquired from the sensor unit 10 (S50).

Next, the processing unit 21 analyzes the swing exercise of the user 2 using the detection result of each motion in step S40 or the position and the posture of the sensor unit 10 calculated in step S50, generates analysis information which is the analysis result, causes the display unit 25 to display the analysis information (S60), and ends the process. In step S60, for example, the processing unit 21 analyzes the rhythm or the tempo of the swing using the detection result of each motion in step S40 and analyzes the trajectory of the swing of the head or the grip of the golf club 3 or a head speed or a grip speed at the time of the impact using the position and the posture of the sensor unit 10 calculated in step S50, the club specification information 242, and the sensor-mounted position information 244. In step S60, the processing unit 21 may analyze an angle of incidence (club pass) of the head, a face angle, or shaft rotation at the time of impact, a deceleration rate of the head, a variation in each piece of information when the user 2 performs the swing a plurality of times.

In the flowchart of FIG. 8, the sequence of the steps may be appropriately changed within a possible range.

### Motion Detection Process

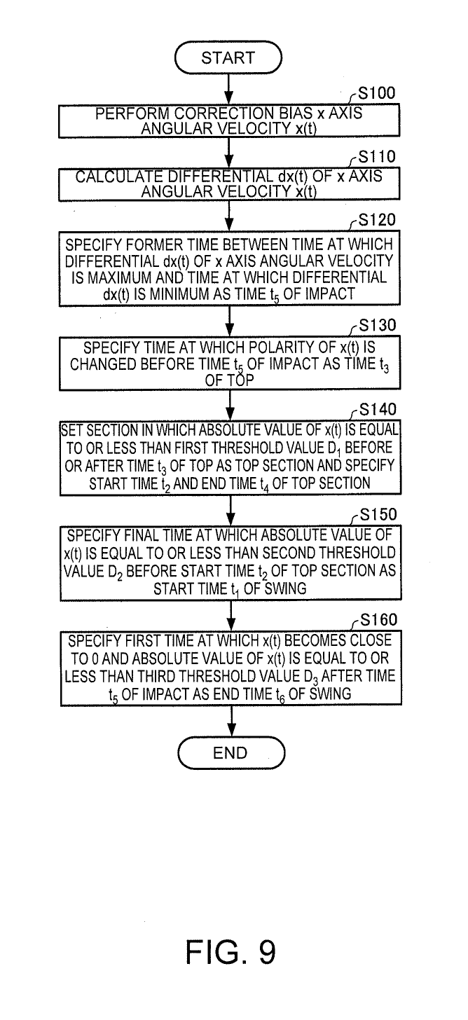

FIG. 9 is a flowchart illustrating a procedure example of the process (the process of step S40 of FIG. 8) of detecting each motion in a swing of the user 2. In the example of FIG. 9, the processing unit 21 detects each motion of the swing of the user 2 using data of the angular velocity generated around one axis (x axis) which is closest to the rotation axis of the radial deviation direction and the ulnar deviation direction of the wrist of the user 2. Hereinafter, the flowchart of FIG. 9 will be described.

First, the processing unit 21 performs bias correction on the data of the angular velocity (x angular velocity data) generated around the x axis and included in the measurement data acquired in step S10 of FIG. 8 (S100).

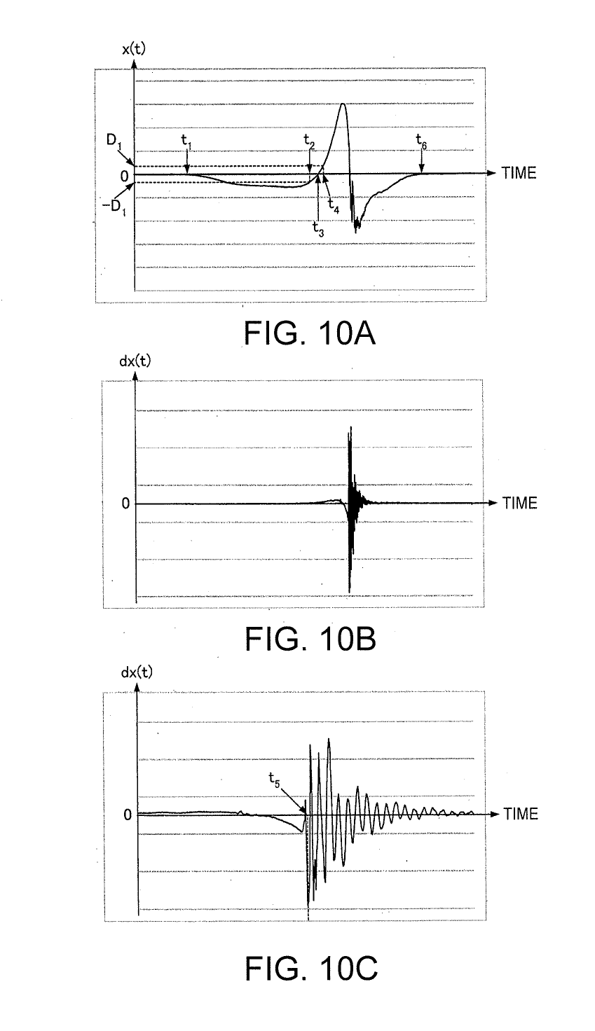

An example of the x axis angular velocity data when the user 2 performs a swing to hit the golf ball 4 is illustrated in FIG. 10A. In FIG. 10A, the horizontal axis represents a time and the vertical axis represents an angular velocity.

Next, the processing unit 21 calculates a differential dx(t) of an x axis angular velocity x(t) at each time t (S110). For example, when Δt is assumed to be a measurement period of the x axis angular velocity data, a differential (difference) dx(t) of the x axis angular velocity at time t is calculated in the following formula (1).

dn(t)=n(t)−n(t−Δt) (1)

FIG. 10B is a diagram illustrating a graph of the differential dx(t) when the differential dx(t) is calculated from the x axis angular velocity x(t) of FIG. 10A according to formula (1). FIG. 10C is a diagram enlarging and displaying the vicinity of an impact in the graph of FIG. 10B. In FIGS. 10B and 10C, the horizontal axis represents a time and the vertical axis represents a differential value of the x axis angular velocity.

Next, the processing unit 21 specifies a former time as time t₅ of the impact between a time at which the value of the differential dx(t) of the x axis angular velocity is the maximum and a time at which the differential dx(t) of the x axis angular velocity is the minimum (S120) (see FIG. 10C). In a normal golf swing, a swing velocity is considered to be the maximum at a moment of an impact. Then, since the value of the x axis angular velocity is considered to be changed according to the swing velocity, a timing at which the differential value of the x axis angular velocity in a series of swing motions is the maximum or the minimum (that is, a timing at which the differential value of the x axis angular velocity is the positive maximum value or the negative minimum value) can be captured as the timing of the impact. Since the golf club 3 is vibrated due to the impact, the timing at which the differential value of the x axis angular velocity is the maximum is considered to be paired with the timing at which the differential value of the x axis angular velocity is the minimum. The former timing between the timings is considered to be the moment of the impact.

Next, the processing unit 21 specifies a time at which the polarity of the x axis angular velocity x(t) is changed before time t₃ of the impact (a time at which the polarity is changed finally) as time t₃ of the top (S130) (see FIG. 10A). In a normal golf swing, from a backswing to a downswing, the rotation axis (which is an axis vertical to a swing plane) of the golf club 3 is close to be parallel to the rotation axis of the radial deviation direction and the ulnar deviation direction of the wrist of the user 2. Accordingly, since the rotation direction of the golf club 3 is changed at the top at which the swing is changed from the backswing to the downswing, a timing at which the minimum of the x axis angular velocity is changed before the timing of the impact can be captured as a timing of the top.

Next, the processing unit 21 sets a section in which the absolute value of the x axis angular velocity x (t) is equal to or less than the first threshold value D₁ before or after time t₃ of the top as a top section and specify start time t₂ and end time t₄ of the top section (S140). In a normal golf swing, s motion is temporarily stopped at the top. Therefore, the value of a rotation velocity of the golf club 3 is considered to be small before or after the top. Accordingly, a section in which the value of the x axis angular velocity is continuously equal to or less than the first threshold value D₁, including the timing of the top, can be captured as the top section. The first threshold value D₁ is set as a proper value for specifying the top section with high accuracy.

Next, the processing unit 21 specifies the final time at which the absolute value of the x axis angular velocity x (t) is equal to or less than the second threshold value D₂ before start time t₂ of the top section as start time t₁ of the swing (S150) (see FIG. 10A). In a normal golf swing, it is difficult to consider that a swing motion is started from a stop state and the swing motion is stopped until the top. Accordingly, a final timing at which the absolute value of the x axis angular velocity is equal to or less than the second threshold value D₂ before the start timing of the top can be captured as a start timing of a swing motion. The second threshold value D₂ is set to a proper value for specifying the start timing of a swing with high accuracy.

Next, the processing unit 21 specifies a first time at which the x axis angular velocity x(t) becomes close to 0 and the absolute value of the x axis angular velocity x(t) is equal to or less than the third threshold value D₃ after time t₃ of the impact as end time t₆ of the swing (S160) (see FIG. 10A), and then the process ends. In a normal golf swing, a swing velocity is considered to decrease gradually and stop after an impact. Accordingly, the first timing at which the x axis angular velocity becomes close to 0 and the absolute value of the x axis angular velocity is equal to or less than the third threshold value D₃ after the timing of the impact can be captured as the end timing of the swing motion. The third threshold value D₃ is set as a proper value for specifying the end timing of a swing with high accuracy.

In the flowchart of FIG. 9, the sequence of the steps can be appropriately change within a possible range. In the flowchart of FIG. 9, the processing unit 21 specifies the time of the impact using the x axis angular velocity, but may specify the time of the impact using the y axis angular velocity or the z axis angular velocity or may specify the time of the impact using a composite value of the angular velocities of any two axes or a composite value of triaxial angular velocities.

In the flowchart of FIG. 9, the processing unit 21 detects a swing motion using the x axis angular velocity data. However, for example, the angular velocity data of two axes such as the x axis angular velocity data and the z axis angular velocity data may be used to detect a swing motion. In this case, in step S110, the processing unit 21 may calculate a composite value (for example, the value of a square root of a sum of squares) n(t) of biaxial angular velocities and a differential value dn(t) of the composite value, replace the x axis angular velocity x(t) with the composite value n(t) of the biaxial angular velocities, and replace the differential dx(t) of the x axis angular velocity with the differential dn(t) of the composite value of the biaxial angular velocities, and then may perform the processes subsequent to step S120.

The processing unit 21 may perform part (for example, the impact detection process of S120) of the processes of the flowchart of FIG. 9 using any uniaxial acceleration value among triaxial acceleration data, a composite value of accelerations of any two axes, or a composite value of the triaxial accelerations.

### Analysis Process for Swing Rhythm and Swing Tempo

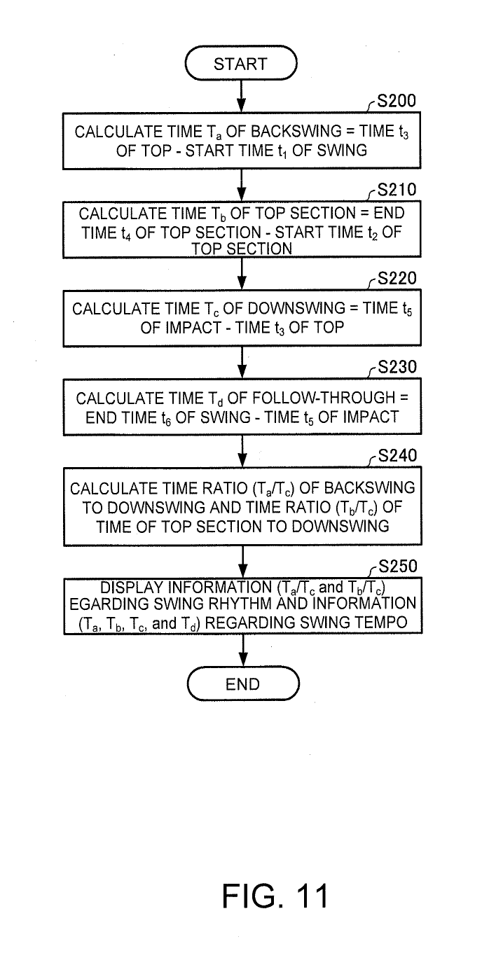

FIG. 11 is flowchart illustrating a procedure example of the analysis process (the process of a part of step S60 of FIG. 8) for a swing rhythm and a swing tempo. Hereinafter, the flowchart of FIG. 11 will be described.

The processing unit 21 first calculates “time Tₐ of a backswing=time t₃ of the top−start time t₁ of the swing” using time t₃ of the top specified in step S130 of FIG. 9 and start time t₁ of the swing specified in step S150 (S200).

Next, the processing unit 21 calculates “time T_{b} of the top section=end time t₄ of the top section−start time t₂ of the top section” using start time t₂ and end time t₄ of the top specified in step S140 of FIG. 9 (S210).

Next, the processing unit 21 calculates “time T_{c} of the downswing=time t₅ of the impact−time t₃ of the top” using time t₅ of the impact specified in step S120 of FIG. 9 and time t₃ of the top specified in step S130 (S220).

Next, the processing unit 21 calculates “time T_{d} of the follow-through=end time t₆ of the swing−time t₅ of the impact” using time t₅ of the impact specified in step S120 of FIG. 9 and end time t₆ of the swing specified in step S160 (S230).

Next, the processing unit 21 calculates a time ratio (time Tₐ of the backswing/time T_{c} of the downswing) of the backswing to the downswing and a time ratio (time T_{b} of the top section/time T_{c} of the downswing) of the time of the top section and the downswing using the information calculated in steps S200, S210 and S220 (S240).

Next, the processing unit 21 displays the information (the time ratio (Tₐ/T_{c}) of the backswing to the downswing and the time ratio (T_{b}/T_{c}) of the time of the top section to the downswing) regarding the swing rhythm and the information (time Tₐ of the backswing, the time T_{b} of the top section, the time T_{c} of the downswing, and the time T_{d} of the follow-through) regarding the swing tempo on the display unit 25 (S250) using the information calculated in steps S200 to S240, and then the process ends.

### 1-4. Advantages

In the embodiment, the exercise analysis device 20 detects a motion of a swing exercise using detection data of an angular velocity, unlike a method of the related art in which a motion of a swing is detected using detection data of acceleration, by noting that an angular velocity is necessarily generated by rotation and a change amount of angular velocity is large at the time of switching of a swing in a swing exercise. Accordingly, in the embodiment, the exercise analysis device 20 can detect a motion in a swing more accurately than in the related art.

In particular, in the embodiment, since the rotation axis (which is an axis vertical to a swing plane) of the swing from the backswing to the downswing is close to the rotation axis (which is an axis vertical to the face plane of the golf club 3) of the radial deviation direction and the ulnar deviation direction of the wrist of the user 2, the exercise analysis device 20 can detect a motion (particularly, a top of a swing) of a swing with high accuracy by using the detection data of the angular velocity generated around a detection axis (for example, the x axis) at which an angle formed with the rotation axis is the smallest (close to be parallel to the rotation axis).

In the embodiment, the exercise analysis device 20 acquires the detection data of the angular velocities generated around the three axes of the sensor unit 10, and thus can calculate the posture of the sensor unit 10 using the detection data of the angular velocities generated around the three axes to generate various kinds of analysis information.

On the other hand, when the exercise analysis device 20 detects a motion of a swing, the exercise analysis device 20 can also use detection data of angular velocities generated around some of the detection axes (one axis or two axes). In this case, it is possible to reduce a calculation amount more than when detection data of angular velocities generated around three axes is used.

In the embodiment, the exercise analysis device 20 detects other motions using the timing of an impact easily detected due to a sharp change in an angular velocity as a criterion in the motion detection of the swing. Therefore, it is possible to reduce a concern of erroneous detection.

In the embodiment, the exercise analysis device 20 calculates a differential of an angular velocity in the detection of an impact, and thus a change amount of angular velocity is clear as a numerical value. Therefore, it is possible to detect the timing of the impact more accurately.

In the embodiment, the exercise analysis device 20 can generate and suggest high reliable information regarding a rhythm or a tempo of a swing based on a motion of the swing detected with high accuracy.

### 2. MODIFICATION EXAMPLES

The invention is not limited to the embodiments, but may be modified in various forms within the scope of the gist of the invention.

In the foregoing embodiments, the sensor unit 10 is fitted on the golf club 3, but the invention is not limited thereto. The sensor unit 10 may be fitted on a hand of the user 2, a glove, or the like or may be fitted on an accessory of a wristwatch.

In the foregoing embodiments, the acceleration sensor 12 and the angular velocity sensor 14 are built in the sensor unit 10 to be integrated. However, the acceleration sensor 12 and the angular velocity sensor 14 may not be integrated. Alternatively, the acceleration sensor 12 and the angular velocity sensor 14 may not be built in the sensor unit 10, but may be directly mounted on the golf club 3 or the user 2. In the foregoing embodiments, the sensor unit 10 and the exercise analysis device 20 are separated from each other. The sensor unit 10 and the exercise analysis device 20 may be integrated to be able to be mounted on the golf club 3 or the user 2.

In the foregoing embodiments, the exercise analysis system (the exercise analysis device) analyzing a golf swing has been exemplified, but the invention can be applied to an exercise analysis system (exercise analysis device) analyzing swings of various exercises such as tennis and baseball. Further, the invention can also be applied to an exercise analysis system (exercise analysis device) analyzing various rotational reciprocation exercises accompanied with rotation and reciprocation other than swings.

The foregoing embodiments and modification examples are merely examples, but the invention is not limited thereto. For example, the embodiments and the modification examples can also be appropriately combined.

The invention includes configurations (for example, configurations in which functions, methods, and results are the same or configurations in which objects and advantages are the same) which are substantially the same as the configurations described in the embodiments. The invention includes configurations in which non-essential portions of the configurations described in the embodiments are substituted. The invention includes configurations in which the same operational advantages as the configurations described in the embodiments are obtained or configurations in which the same objects can be achieved. The invention includes configurations in which known technologies are added to the configurations described in the embodiments.

The entire disclosure of Japanese Patent Application No. 2014-197268, filed Sep. 26, 2014 is expressly incorporated by reference herein.

What is claimed is:

1. An exercise analysis device comprising:
a data acquisition unit that acquires detection data of angular velocities generated around a plurality of axes in a swing exercise of a user; and
a motion detection unit that detects a motion of the swing exercise using detection data of an angular velocity generated by radial deviation or ulnar deviation of a wrist of the user among the detection data.

2. The exercise analysis device according to claim 1,
wherein the motion detection unit uses detection data of an angular velocity of an axis at which the angular velocity generated by the radial deviation or the ulnar deviation of the wrist of the user is relatively larger than the angular velocities of the other axes among the detection data of the angular velocities generated around the plurality of axes.

3. An exercise analysis device comprising:
a data acquisition unit that acquires detection data of angular velocities generated around a plurality of axes in a swing exercise of a user; and
a motion detection unit that detects a motion of the swing exercise using, among the detection data, detection data of an angular velocity of an axis at which a change amount of angular velocity relatively larger than the angular velocities of the other axes when a direction of a swing is switched in the swing exercise.

4. The exercise analysis device according to claim 1,
wherein the motion detection unit detects an impact in the swing exercise based on the detection data used to detect a motion and detects a motion of the swing exercise using the impact as a criterion.

5. The exercise analysis device according to claim 4,
wherein the motion detection unit differentiates the angular velocity of the detection data used to detect a motion of the swing exercise and detects the impact based on the differential result.

6. The exercise analysis device according to claim 4,
wherein the motion detection unit detects a portion in which positive and negative values of the angular velocity are switched before the impact as a top of the swing exercise.

7. The exercise analysis device according to claim 6,
wherein the motion detection unit detects a portion in which the angular velocity is equal to or less than a predetermined threshold value before the top as start of the swing exercise.

8. The exercise analysis device according to claim 4,
wherein the motion detection unit detects a portion in which the angular velocity is equal to or less than a predetermined threshold value after the impact as end of the swing exercise.

9. An exercise analysis system comprising:
the exercise analysis device according to claim 1; and
a sensor that generates detection data.

10. An exercise analysis system comprising:
the exercise analysis device according to claim 3; and
a sensor that generates detection data.

11. An exercise analysis method comprising:
acquiring detection data of angular velocities generated around a plurality of axes in a swing exercise of a user; and
detecting a motion of the swing exercise using detection data of an angular velocity generated by radial deviation or ulnar deviation of a wrist of the user among the detection data.

12. The exercise analysis method according to claim 11,
wherein in the detecting of the motion of the swing exercise, detection data of an angular velocity of an axis at which the angular velocity generated by the radial deviation or the ulnar deviation of the wrist of the user is relatively larger than the angular velocities of the other axes is used among the detection data of the angular velocities generated around the plurality of axes.

13. An exercise analysis method comprising:
acquiring detection data of angular velocities generated around a plurality of axes in a swing exercise of a user; and
detecting a motion of the swing exercise using, among the detection data, detection data of an angular velocity of an axis at which a change amount of angular velocity relatively larger than the angular velocities of the other axes when a direction of a swing is switched in the swing exercise.

14. The exercise analysis method according to claim 11,
wherein in the detecting of the motion of the swing exercise, an impact in the swing exercise is detected based on the detection data used to detect a motion and a motion of the swing exercise is detected using the impact as a criterion.

15. The exercise analysis method according to claim 14,
wherein in the detecting of the motion of the swing exercise, the angular velocity of the detection data used to detect a motion of the swing exercise is differentiated and the impact is detected based on the differential result.

16. The exercise analysis method according to claim 14,
wherein in the detecting of the motion of the swing exercise, a portion in which positive and negative values of the angular velocity are switched before the impact is detected as a top of the swing exercise.

17. The exercise analysis method according to claim 16,
wherein in the detecting of the motion of the swing exercise, a portion in which the angular velocity is equal to or less than a predetermined threshold value before the top is detected as start of the swing exercise.

18. The exercise analysis method according to claim 14,
wherein in the detecting of the motion of the swing exercise, a portion in which the angular velocity is equal to or less than a predetermined threshold value after the impact is detected as end of the swing exercise.

19. A program causing a computer to perform:
acquiring detection data of angular velocities generated around a plurality of axes in a swing exercise of a user; and
detecting a motion of the swing exercise using detection data of an angular velocity generated by radial deviation or ulnar deviation of a wrist of the user among the detection data.

20. A program causing a computer to perform:
acquiring detection data of angular velocities generated around a plurality of axes in a swing exercise of a user; and
detecting a motion of the swing exercise using, among the detection data, detection data of an angular velocity of an axis at which a change amount of angular velocity relatively larger than the angular velocities of the other axes when a direction of a swing is switched in the swing exercise.
